(19) United States
(12) Patent Application Publication
(10) Pub. No.: US 2024/0156289 A1
(43) Pub. Date: May 16, 2024

(54) Handheld Silicone Holder for Food Items

(71) Applicant: Tasha Turko, McCreary (CA)

(72) Inventor: Tasha Turko, McCreary (CA)

(21) Appl. No.: 18/499,317

(22) Filed: Nov. 1, 2023

Related U.S. Application Data
(60) Provisional application No. 63/425,360, filed on Nov. 15, 2022.

(51) Int. Cl. A47G 21/00

(52) U.S. Cl. CPC A47G 21/001

(57) ABSTRACT

The present invention relates to a flexible handheld silicone holder device for accommodating food items such as sandwiches, hamburgers, subs, and more. More specifically, the silicone holder is designed to accommodate a food item and replaces a paper wrap typically used to hold a food item. The holder provides a cavity for storing a food item such that liquid, crumbs, and other items dripping from the food item is collected at the bottom of the device, thereby enabling individuals to eat without worry of ruining their clothes and vehicles, thereby obviating significant cleaning. In exemplary embodiments, the device is reusable and can be washed for reuse. The holder device is made of food grade silicone and includes different sizes and shapes for accommodating different types of food items.

### CROSS-REFERENCE TO RELATED APPLICATION

The present application claims priority to, and the benefit of, U.S. Provisional Application No. 63/425,360, which was filed on Nov. 15, 2022, and is incorporated herein by reference in its entirety.

### FIELD OF THE INVENTION

The present invention relates generally to the field of food item holder devices. More specifically, the present invention relates to a novel food grade silicone holder device for accommodating food items. The device is designed to replace conventional paper wrappers and is configured to accommodate a food item such that any liquid drips from the food item is collected in the device itself, therefore, enables individuals to eat without worry of ruining their clothes, vehicle upholstery, and obviates significant cleaning of same. Accordingly, the present disclosure makes specific reference thereto. Nonetheless, it is to be appreciated that aspects of the present invention are also equally applicable to other like applications, devices, and methods of manufacture.

### BACKGROUND

By way of background, it is common for individuals to purchase ready-to-eat food items such as sandwiches, burgers, French fries, and other snacks while travelling such as going to the home or the office. Such food items are generally purchased from fast-food restaurants and convenience stores and can be readily eaten by individuals while driving. Superstores, restaurants, and convenience stores provide these food items wrapped in a paper wrapper which often becomes too soiled and messy. A user has to tear or remove a portion of the paper wrapper for eating the food item.

While eating food items wrapped in a paper wrapper, food may drip onto a person's lap, hands, or on a vehicle's upholstery and can cause damage to the vehicle. Further, it is difficult to handle and dispose of such a messy paper wrapper. A common problem with use of different types of packaging paper for wrapping foods is that various toxic chemicals, such as printing inks, phthalates, surfactants, bleaching agents, hydrocarbons etc. are incorporated in the paper during its development process which may contaminate food consumption.

Many wrapping papers are insufficient for food products because of poor barrier properties, low heat sealability, and strength. Also, tons of waste are generated by use of disposable papers for wrapping ready-to-eat food items which is harmful for the environment and cleanliness of surroundings. Other problems that may be associated with conventional paper wrappers are stickiness to food items which may alter taste of the food item and may impart toxins thereto.

Restaurant workers are required to spend some time for effectively wrapping food items in conventional packaging papers. This not only reduces their efficiency but often, the food item is not correctly packaged. Individuals need an improved portable food item holder which can overcome the problems associated with standard paper wrappers for food items.

Therefore, there exists a long-felt need in the art for a food item wrapping device that can accommodate sandwiches, hamburgers, subs, and other food items. There is also a long-felt need in the art for an improved handheld food item holding device that can replace conventional standard paper wrappers for holding and wrapping ready-to-eat food items. Additionally, there is a long-felt need in the art for a handheld food item pocket device that is reusable and environmentally friendly. Moreover, there is a long-felt need in the art for a food item pocket device that eliminates dripping of food onto a person's lap, hands, or on a vehicle's upholstery. Further, there is a long-felt need in the art for a silicone handheld pocket device that is easy to secure and accommodate food items. Furthermore, there is a long-felt need in the art for a food item wrapping device that is easy to use and cost-effective for restaurants and convenience stores. Finally, there is a long-felt need in the art for a silicone handheld pocket device that offers a simple, reusable, and dishwasher-safe product for holding food while eating on the go.

The subject matter disclosed and claimed herein, in one embodiment thereof, comprises a silicone handheld pocket device for helping individuals hold burgers, subs, sandwiches, and other similar food items safely without creating a mess while on-the-go, in the car, and/or during commuting. The silicone handheld pocket device is designed to replace conventional standard paper wrappers for wrapping and accommodating food items. More specifically, the device holds a portion of a food item therein, such that another portion of the food item is accessible to a user for eating, while the bottom end of the device collects the material dripping from the food, thereby preventing mess on clothing or a vehicle's interior (i.e., floor or seat). The device may be available in a variety of shapes and sizes for accommodating different types of food items.

In this manner, the silicone handheld food item pocket device of the present invention accomplishes all of the forgoing objectives and provides users with a device that accommodates sandwiches, hamburgers, subs, and other food items. The device allows users to place their food items in the silicone holder rather than in a flimsy paper wrap, reducing the chance of any liquid drips from the food staining clothing or vehicle upholstery. The device is reusable and reduces packaging costs and waste while improving the eating experience for consumers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a silicone handheld pocket device designed to help individuals hold burgers, subs, sandwiches, and other similar food items while on-the-go, in the car, and/or during commuting. The silicone handheld pocket device is designed to replace conventional standard paper wrappers for securing and accommodating food items. More specifically, the device holds a first portion of food item therein, such that a second portion of the food item is accessible to a user for eating, while the bottom end of the device collects the food materials, crumbs, and/or condiments dripping from the food, thereby preventing mess on clothing or a vehicle interior. The device may be available in a variety of shapes and sizes for accommodating different types of food items.

In a further embodiment of the present invention, a silicone holder device for accommodating a food item such as a sandwich, hamburger, wrap, or more is disclosed. The device includes a generally cuboidal or oval shape having a top opening and a closed bottom end, a continuous cavity formed between the top opening and the closed bottom end such that the cavity provides a space for accommodating the food item, or portion thereof. The food item is stored in the cavity such that a portion of the food item rests on the bottom end and another portion of the food item is accessible from the top opening. A side lining or horizontal lip extends horizontally or orthogonally around or outward from the top edge of the device for providing support and preventing slippage of the device. In use, the device is held by a user in one or both hands such that a portion of the food item extending out of the top opening is accessible to the user for eating.

In a further embodiment of the present invention, the device is made from food grade silicone and has a logo for marketing and advertising purposes.

In a further embodiment of the present invention, a method for eliminating the chance of any liquid drips from a food carrying by a user and staining clothing or vehicle upholstery is described. The method comprises the initial step of accessing a silicone holder designed to accommodate a food item. Next, storing the food item inside a cavity of the silicone holder such that the food item rests on the bottom of the holder. In use, a portion of the food item is eaten by the user while the items dripping or dropping from the food item is collected at the bottom of the holder. The holder is slightly pressed for taking or extending a second portion of the food item out from the device when the already extended out portion of the food item is eaten by the user.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a silicone handheld food storing pocket device of the present invention in accordance with the disclosed architecture;

FIG. 2 illustrates a perspective view of the food pocket silicone device of FIG. 1 accommodating a sandwich in accordance with the disclosed architecture;

FIG. 3 illustrates a perspective view of one potential embodiment of the pocket device for a food item of the present invention in accordance with the disclosed architecture, wherein the pocket device holds a food item that is being consumed by a user; and

FIG. 4 illustrates a perspective view of another potential embodiment of the food item holder handheld silicone device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a food item wrapping device that can accommodate sandwiches, hamburgers, subs, and other food items. There is also a long-felt need in the art for an improved handheld food item holding device that can replace conventional standard paper wrappers for holding and securing ready-to-eat food items. Additionally, there is a long-felt need in the art for a handheld food item pocket device that is reusable and environmentally friendly. Moreover, there is a long-felt need in the art for a food item pocket device that eliminates dripping of food, crumbs, and condiments onto a person's lap, hands, or on a vehicle's upholstery. Further, there is a long-felt need in the art for a silicone handheld pocket device that is easy to secure and accommodate food items therewith. Furthermore, there is a long-felt need in the art for a food item wrapping device that is easy to use and cost-effective for restaurants and convenience stores. Finally, there is a long-felt need in the art for a silicone handheld pocket device that offers a simple, reusable, and dishwasher-safe product for holding food while eating on the go.

The present invention, in one exemplary embodiment, is an anti-microbial and flexible silicone holder device for accommodating a food item such as a sandwich, hamburger, wrap, or more. The device includes a generally cuboidal or oval shape having a top opening and a closed bottom end, a continuous cavity formed between the top opening and the bottom end such that the cavity provides a space for accommodating the food item. The cavity is surrounded by an interior wall surface of silicone. The food item is stored in the cavity such that a portion of the food item rests on the bottom end while another portion of the food item is accessible from the top opening. A side lining or horizontal lip extends horizontally or orthogonally around and along the top edge of the device for providing support and preventing slippage of the device. In use, the device is held by a user in one or both hands such that a portion of the food item extending out of the top opening is accessible to the user for eating.

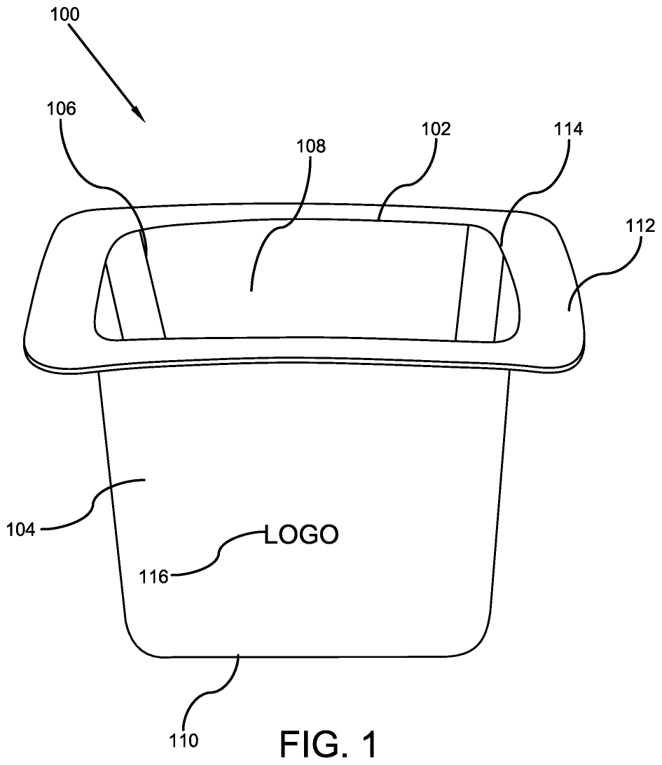

Referring initially to the drawings, FIG. 1 illustrates a perspective view of one potential embodiment of silicone handheld food storing pocket device of the present invention in accordance with the disclosed architecture. The silicone handheld food storing pocket device 100 of the present invention is a generally cuboidal or oval piece of silicone material which has a continuous top opening 102, an exterior or outer surface 104, and an interior or inner surface 106. As a point of reference, the exterior or outer surface 104 refers to the surface of the pocket device 100 that is touched by a user for holding the device 100. By comparison, the interior or inner surface 106 refers to the surface of the pocket device 100 that touches a food item accommodated by the device 100. As explained more fully below, the food item holding silicone device 100 of the present invention is designed to hold burgers, subs, sandwiches, and other similar food items.

In operation, cavity 108 formed by the interior or inner surface 106 is used for accommodating a food item such that a portion of the food item is accessible to a user and a remaining portion of the food item remains is secured in the cavity 108. The device 100 is closed at the bottom with a bottom wall 110 and the cavity 108 extends from the top opening 102 to the bottom wall 110. The bottom wall 110 is used for collecting food, crumbs, and condiments dripping or falling from the food item such that food/condiment is not dripped onto a person's lap, hands, or onto a vehicle's upholstery. A continuous horizontal top lining or horizontal lip 112 extending from the top edge 114 of the device 100 is designed to protect any food dripping from the sides of the device 100 and further, helps a user in holding the device 100 easily.

In exemplary embodiments, the device 100 may be reusable or disposable to accommodate the requirements of the users when consuming food items at home, on-the-go, commuting, and more. The reusable version is dishwasher safe and scratch proof. The disposable version of the device 100 may be a single use item which can be thrown away and can be discarded once the device 100 has been used. The reusable version of the device 100 may be used time and time again, after it has been washed and/or otherwise sanitized. For both the reusable and disposable versions, the silicone may be recycled.

The food pocket silicone device 100 of all the embodiments of the present invention is made of FDA food grade silicone which is antifungal and has non-stick properties. The silicone material is free of harmful fillers such as BPS and BPA, making it non-toxic and contributing to its food-safe status. The durable nature of silicone enables the device 100 to have resistance to environmental and external elements such as aging, weathering, and ozonation. The device 100 is resistant to extreme temperatures, both hot and cold. It can withstand anywhere between −30° C. and up to 130° C. without losing its shape or durability. It is to be appreciated that the food grade silicone is also microwavable and also able to withstand freezer conditions.

The device 100 is flexible and the exterior or outer surface 104 can be pressed or squeezed by a user during use to hold the accommodated food item inside the cavity 108 without the food item resting or touching the bottom of the device. This assists a user to continually access the food item for eating when only a small portion of the food item remains. The pocket device 100 may also have an antimicrobial coating, or the antimicrobial coating may be integrated directly into the silicone making up the device 100 as an added precaution against the possible transmission of germs, bacteria, disease, and the like.

The width of the food pocket device (as measured along a face of the device 100 is preferably from about 40 mm (1.9 inches) to about 80 mm (3.14 inches), with about 50 mm (1.6 inches) to about 70 mm (2.8 inches) being preferred. By comparison, the length of the device 100 ranges from about 120 mm (4.7 inches) to about 180 mm (7.0 inches). The length and width of the of the device 100 along with the shape are designed so that different types of food items can be easily accommodated inside the device. When a food item is placed inside the device 100, the bottom 110 catches whatever falls or drips out of the food item.

The exterior or outer surface 104 may further comprise different indicia 116, such as designs, patterns, a company logo, personalized name, customized design, or the like, as per the requirements of the user. The indicia 116 may also include instructions relating to the use of the device 100. The silicone handheld food storing pocket device 100 may be made available in different sizes and colors to accommodate user needs and/or preferences, and the exact size, measurement, construction, and design specifications of the device 100 of the present invention may vary depending upon manufacturing or the particular material that is used.

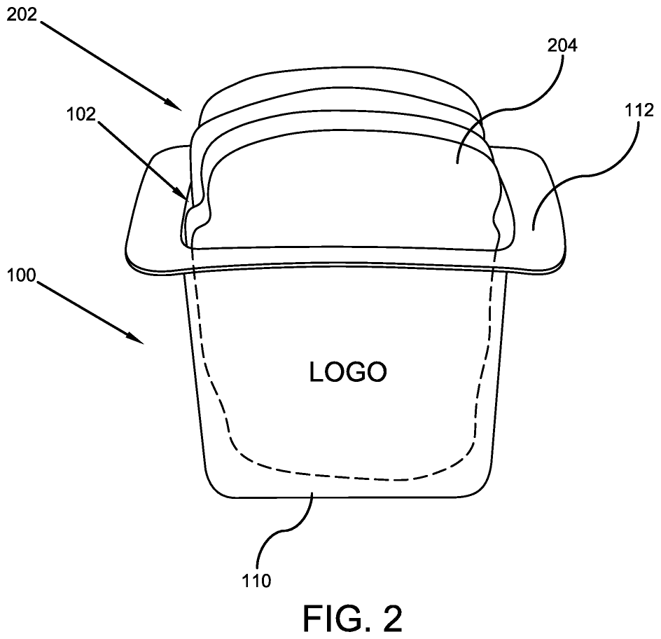

FIG. 2 illustrates a perspective view of the food pocket silicone device of FIG. 1 accommodating a sandwich in accordance with the disclosed architecture. For storing a food item such as an exemplary sandwich 202, the device 100 designed and shaped to accommodate the sandwich 202 is used by a user. The sandwich 202 is kept inside the device 100 such that the sandwich 202 rests on the bottom wall 110 and at least a portion 204 of the sandwich 202 extends out of the top opening 102 of the device 100.

The device 100, as illustrated, securely stores the sandwich 202 with all the items that have dripped from the sandwich 202 being stored at the bottom of the device 100, thereby eliminating dripping onto clothes and thus avoiding a mess. During use, a user can extend a portion of the sandwich 202 out of the top opening 102 while securing the remaining covered portion by slightly pressing the exterior or outer surface 104. The device 100 in the preferred embodiment can be washed and reused by a user. The device 100 eliminates time consuming and ineffective paper wrapper to wrap a food item for eating while commuting and on-the-go.

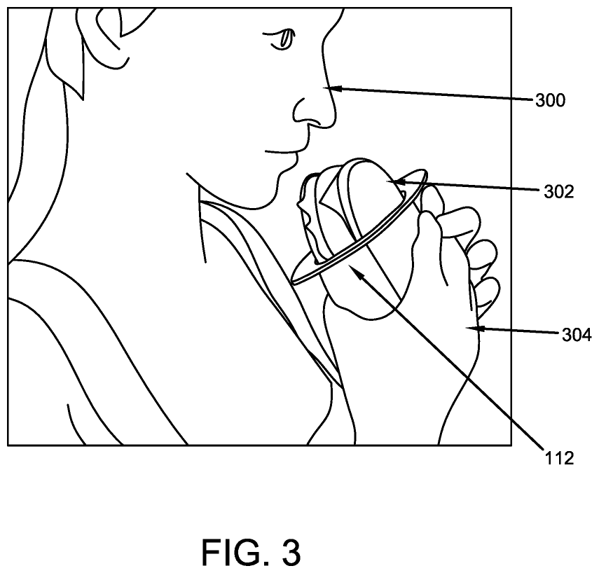

FIG. 3 illustrates a perspective view of one potential embodiment of the pocket device for a food item of the present invention in accordance with the disclosed architecture, wherein the pocket device holds a food item that is being consumed by a user. The user 300 can place the food item 302, such as a hamburger, inside the device 100 and can hold the device 100 using the exterior or outer surface 104 for eating the food item 302. The lining or horizontal lip 112 prevents the device 100 from slipping through the hands 304 of the user 300 while also protecting food from dripping over the sides of the device 100. The user 300 can easily eat food items 302 while walking, sitting or driving in a car, and/or during any movement without worry of ruining their clothes and requiring significant cleaning.

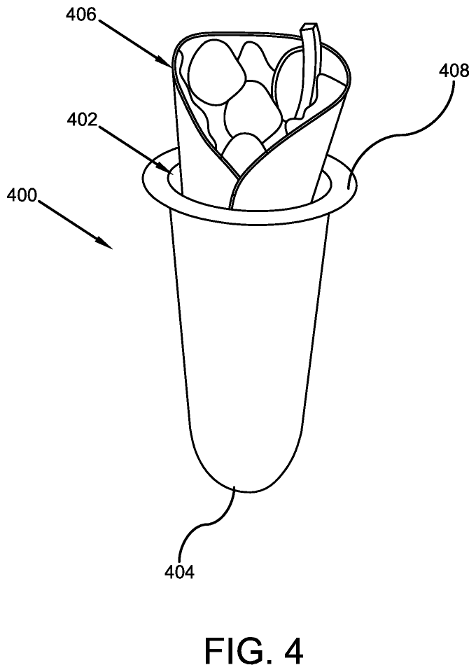

FIG. 4 illustrates a perspective view of another potential embodiment of the food item holder handheld silicone device of the present invention in accordance with the disclosed architecture. The device 400 of the present embodiment is in an oval, oblong, or tubular shape with a slightly broad top opening 402 and a narrower bottom end 404. The device 400 is especially designed for use with a wrap type or burrito type sandwich 406 and can have a length in a range from about 130 mm (5.1 inches) to about 280 mm (11.0 inches). The side lining or horizontal lip 408 is uniform and may have a width (i.e., length of extension) of from about 20 mm (0.7 inches) to about 30 mm (1.1 inches). Other manufacturing specifications may remain same as of the manufacturing of the devices of other embodiments of the present invention.

The food pocket device 100, 400 can be packaged as single use, or as a reusable device in different pouches. Notwithstanding, the packaging of the pocket device is not so limited and can be packaged in other variations and designs as per the preferences of a user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pocket device”, “device”, “silicone handheld food storing pocket device”, and “food pocket silicone device” are interchangeable and refer to the food item holder handheld silicone device 100, 400 of the present invention.

Notwithstanding the forgoing, the food item holder handheld silicone device 100, 400 of the present invention can be of any suitable size and configuration as is known in the art without affecting the overall concept of the invention, provided that it accomplishes the above stated objectives. One of ordinary skill in the art will appreciate that food item holder handheld silicone device 100, 400 as shown in the FIGS. are for illustrative purposes only, and that many other sizes and shapes of the food item holder handheld silicone device 100, 400 are well within the scope of the present disclosure. Although the dimensions of the food item holder handheld silicone device 100, 400 are important design parameters for user convenience, the food item holder handheld silicone device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld food storing device comprising:
a continuous flexible side wall; and
a flexible bottom wall forming a cavity;
wherein said continuous flexible side wall having a top edge including a lip extending around said top edge;
wherein said continuous flexible side wall and said flexible bottom wall having a flexible outer surface and a flexible inner surface;
wherein said continuous flexible side wall having a height less than a height of a food item;
wherein said lip extending generally orthogonal to said top edge;
wherein said cavity housing a first portion of said food item while a second portion of said food item extends outward from said cavity;
wherein said first portion of said food item gripped by said flexible inner surface when a user squeezes said continuous flexible side wall; and
further wherein said second portion of said food item is accessible for consumption by a user and said flexible bottom wall is used for collecting food crumbs and condiments falling from said food item.

2. The handheld food storing device of claim 1, wherein said cavity is a pocket.

3. The handheld food storing device of claim 2, wherein said handheld food storing device having a material of food grade silicone.

4. The handheld food storing device of claim 3, wherein said handheld food storing device is reusable.

5. The handheld food storing device of claim 4, wherein said handheld food storing device is dishwasher safe.

6. The handheld food storing device of claim 5, wherein said handheld food string device is microwavable.

7. The handheld food storing device of claim 6, wherein said pocket is cuboidal in shape.

8. The handheld food storing device of claim 6, wherein said pocket is tubular in shape.

9. The handheld food storing device of claim 6, wherein said pocket is oval in shape.

10. The handheld food storing device of claim 1, wherein said food item is selected from a group consisting of a sandwich, a burger, a sub, a burrito, and a wrap.

11. The handheld food storing device of claim 10, wherein said handheld food storing device is disposable.

12. A handheld food storing device comprising:
a continuous flexible side wall; and
a flexible bottom wall forming a cavity;
wherein said continuous flexible side wall having a top edge including a lip extending around said top edge;
wherein said continuous flexible side wall and said flexible bottom wall having a flexible outer surface and a flexible inner surface;
wherein said continuous flexible side wall having a height less than a height of a food item;
wherein said lip extending generally orthogonal to said top edge;
wherein said cavity housing a first portion of said food item while a second portion of said food item extends outward from said cavity;
wherein said first portion of said food item gripped by said flexible inner surface when a user squeezes said continuous flexible side wall;
wherein said second portion of said food item is accessible for consumption by a user and said flexible bottom wall is used for collecting food crumbs and condiments falling from the food item;
wherein said cavity is a pocket;
wherein said handheld food storing device is reusable;
wherein said food item is selected from a group consisting of a sandwich, a burger, a sub, a burrito, and a wrap; and
further wherein said handheld food storing device having a material resistant to extreme temperatures from about −30° C. to about 130° C.

13. The handheld food storing device of claim 12, wherein said handheld food storing device having a material of food grade antifungal silicone.

14. The handheld food storing device of claim 13, wherein said handheld food storing device is dishwasher safe.

15. The handheld food storing device of claim 14, wherein said handheld food string device is microwavable.

16. The handheld food storing device of claim 15, wherein said pocket is cuboidal in shape.

17. The handheld food storing device of claim 15, wherein said pocket is tubular in shape.

18. The handheld food storing device of claim 15, wherein said pocket is oval in shape.

19. A handheld food storing device comprising:
a continuous flexible side wall; and
a flexible bottom wall forming a pocket;
wherein said continuous flexible side wall having a top edge including a lip extending around said top edge;
wherein said continuous flexible side wall and said flexible bottom wall having a flexible outer surface and a flexible inner surface;
wherein said continuous flexible side wall having a height less than a height of a food item;
wherein said lip extending generally orthogonal to said top edge;
wherein said pocket housing a first portion of said food item while a second portion of said food item extends outward from said pocket;
wherein said first portion of said food item gripped by said flexible inner surface when a user squeezes said continuous flexible side wall;
wherein said second portion of said food item is accessible for consumption by a user and said flexible bottom wall is used for collecting food crumbs and condiments falling from said food item;
wherein said handheld food storing device is reusable; and
further wherein said pocket having a width and a length, and said length is generally about two times said width.

20. The handheld food storing device of claim 19, wherein said food item is selected from a group consisting of a sandwich, a burger, a sub, a burrito, and a wrap.
